(19) United States
(12) Patent Application Publication
(10) Pub. No.: US 2014/0327160 A1
(43) Pub. Date: Nov. 6, 2014

(54) CARBURETOR

(71) Applicant: VEPEC LIMITED, Lymington, Hampshire (GB)

(72) Inventor: Keith Lawes, Lymington (GB)

(73) Assignee: VEPEC LIMITED, Lymington, Hampshire (GB)

(21) Appl. No.: 14/360,157

(22) PCT Filed: Nov. 27, 2012
(86) PCT No.: PCT/GB2012/000867

§ 371 Date: May 22, 2014

(30) Foreign Application Priority Data
Nov. 28, 2011 (GB) 1120542.4

(51) Int. Cl. F02M 17/16; F02M 7/12

(52) U.S. Cl. CPC F02M 17/16; F02M 7/12
USPC 261/83

(57) ABSTRACT

A carburetor incorporating an air passage, and a fuel passage, and a rotating barrel, the rotating barrel being arranged between the air passage and the fuel passage so that a first portion of its surface is exposed to the air passage, and a second portion of its surface is exposed to the fuel passage. The rotation of the barrel transfers fuel from fuel passage to the air passage via an indent feature, the proportion of that indent feature that is exposed to the air or fuel passage being varied to meter the amount of fuel transferred.

### CROSS-REFERENCE TO RELATED APPLICATION(S)

This is a National Stage Entry into the United States Patent and Trademark Office from International PCT Patent Application No. PCT/GB2012/000867, having an international filing date of Nov. 27, 2012, which claims priority to United Kingdom Patent Application No. GB 1120542.4, filed Nov. 28, 2011, the entire contents of both of which are incorporated herein by reference.

### FIELD OF THE INVENTION

The present invention relates to a carburetor for internal combustion engines.

### DESCRIPTION OF RELATED ART

At present fuel is typically metered into an engine either by a carburetor or a fuel injection system.

Carburetors are normally simple mechanical devices with no electronic control. They have the advantage of being low cost. Carburetors generally meter fuel by utilizing the low pressure that occurs in the inlet manifold of the engine during the inlet stroke to draw the fuel through small precisely sized jets or orifices.

It can be seen that the amount of fuel delivered is empirical and will be determined by several variables, the primary determinants being the magnitude and duration of the pressure differential across the jet, the diameter of the jet, and the viscosity of the fuel.

The jet diameter is particularly crucial, with small differences in diameter producing significant changes in fuel flow. The very small holes required for small engines present a particular challenge to achieve accurately and repeatedly. This leads to considerable production variability between individual carburetors. Small jets also are prone to blockage due to contaminants in the fuel, or to gumming up during periods of inactivity as may occur when a piece of equipment is laid up over the winter.

Fuel injection systems generally utilize a fuel rail pressurized to a known pressure dispensing fuel through a known sized orifice controlled by a solenoid activated valve.

Again the amount of fuel delivered is empirical and controlled by the pressure differential across the orifice, fuel viscosity, orifice dimension, and the time the solenoid valve is held open for.

Fuel injection systems are generally electronically controlled and have the advantage of flexible programmable operation to cope with a wide range of operating conditions. Their main disadvantage is cost and complexity. The injectors, fuel pressurization system and associated high pressure plumbing together with the electronics is a significant additional cost for an engine, in particular for smaller installations. They also require an electrical supply which is again inconvenient on a lower cost installation.

### SUMMARY OF THE INVENTION

The present invention seeks to provide a low cost fuelling system that has significant advantages over both conventional carburetors and fuel injection systems in particular for small engine applications.

According to a first aspect of the invention there is provided a carburetor for an internal combustion engine, the carburetor incorporating an air passage, and a fuel passage, and a rotatable barrel, the rotatable barrel being arranged between the air passage and the fuel passage so that a first portion of its surface is exposed to the air passage, and a second portion of its surface is exposed to the fuel passage, the rotation of the barrel transferring fuel from the fuel passage to the air passage via an indent feature on the surface of the barrel, characterized by fuel moving means by which the fuel within the fuel passage is caused to flow along the fuel passage and over the indent feature on the barrel, so that air brought back into the fuel passage in the indented feature is stripped from the indent feature and replaced by fresh fuel, and that the resulting air bubbles are then carried away from the region of the indent feature by the fuel flow.

Preferably amount of fuel that is conveyed from the fuel passage to the air passage is primarily determined by the volumetric size of the fuel carrying indent.

Preferably the amount of fuel that is conveyed from the fuel passage to the air passage is varied by varying the proportion of the fuel carrying indent that is exposed to the air in the air passage or the fuel in the fuel passage or both.

Preferably the proportion of the fuel carrying indent that is exposed to the air in the air passage or the fuel in the fuel passage or both is variable by moving the rotatable barrel in the direction along its axis of rotation. Preferably, the fuel carrying indent consists of multiple indentations in the form of selectively exposable slots, the total volume of the exposed slots determining the amount of fuel that is transferred between the two passages.

Alternatively the proportion of the fuel carrying indent that is exposed to either the air in the air passage or the fuel in the fuel passage or both is adjusted by moving a separate fuel control mask that masks a portion of the fuel carrying indent from either the air in the air passage or the fuel in the fuel passage or both.

Alternatively the amount of fuel that is conveyed from the fuel passage to the air passage is varied by varying the volumetric size of the indented feature by a sliding component that occupies a variable proportion of the indented feature, the position of the component being varied to vary the volumetric size of the indented feature.

Preferably the air passage forms the inlet tract to an internal combustion engine.

Preferably the rotatable barrel is rotated synchronously with the engine. and may be rotated by a belt driven by the engine. In an alternative embodiment, the barrel may have a plurality of indents equidistantly disposed about the periphery of the barrel.

Preferably the rotation of the barrel is timed so that the or each fuel carrying indent is exposed to the air passage during an inlet stroke of the engine, whether two or four stroke. When more than one indent is provided the rotational speed of the barrel can be reduced, thus reducing wear on the barrel and the energy required to rotate the barrel. Thus, with two indents the rotational speed of the barrel is halved. The movement of the air in the air passage will strip the fuel from the fuel carrying indent(s) in the barrel, displacing the fuel with air which the fuel carrying indent will. then carry back to the fuel passage.

Preferably the fuel in the fuel passage is forced through the fuel passage by a secondary pump or other fluid moving method to move the fuel past the fuel carrying indent on the rotating barrel to ensure that air brought back into the fuel passage from the air passage in the fuel carrying indent is stripped from the rotor and displaced by fresh fuel.

Preferably the fuel carrying indent is a flat machined in the surface of the cylinder to a known depth and length, this depth and length determining the volume of the fuel carrying indent and thus determining the amount of fuel that is transferred between the two passages for a given fuel carrying indent exposure.

Alternatively the fuel carrying indent has variable depth along its length, the variation in depth being used to map the amount of fuel that is carried between the fuel passage and the air passage for a given fuel carrying indent exposure.

Preferably the amount of fuel that is transferred between the air passage and the fuel passage is mapped or controlled by a cam that governs the position of the rotatable barrel, sliding component or fuel control mask, the shape of the cam being used to map the fuelling of the engine.

Alternatively the amount of fuel that is transferred between the air passage and the fuel passage is mapped or controlled by a separate electronic actuator that governs the position of the rotatable barrel, sliding component or fuel control mask.

### DESCRIPTION OF THE DRAWINGS

Preferred embodiments of the present invention will now be described by way of example with reference to the accompanying drawings in which:

FIGS. 1a and 1b shows cross sectional views of a rotating barrel carburetor at full throttle;

FIGS. 2a and 2b shows cross sectional views of a rotating barrel carburetor at part throttle;

FIG. 2c shows a cross sectional end view of a fuel supply pump;

FIGS. 3a, 3b, 3c and 3d show general external views of the rotating barrel;

FIGS. 4a and 4b show general external views of the rotating barrel carburetor;

FIGS. 5a and 5b shows cross sectional views of a second embodiment of a rotating barrel carburetor at full throttle;

FIGS. 6a and 6b shows cross sectional views of a rotating barrel carburetor at part throttle;

FIG. 7 shows general external views of the metering slider; and

FIG. 8 shows a general external view of the rotating barrel with multiple indents.

### DETAILED DESCRIPTION OF EMBODIMENTS OF THE INVENTION

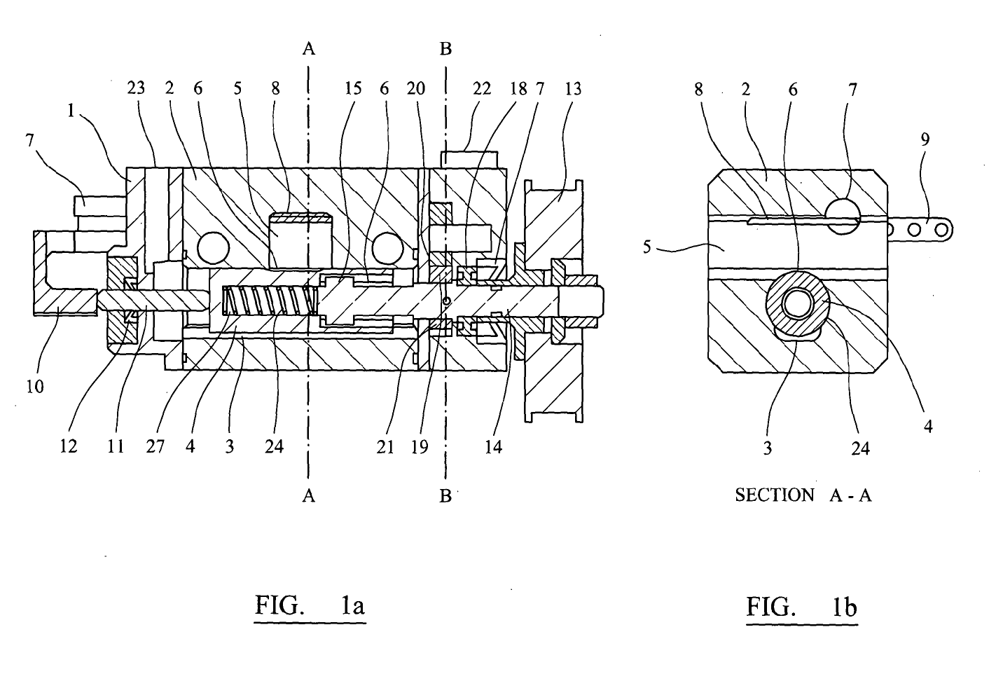

Referring now to FIGS. 1a, 1b and 1c there is shown a rotating barrel carburetor.

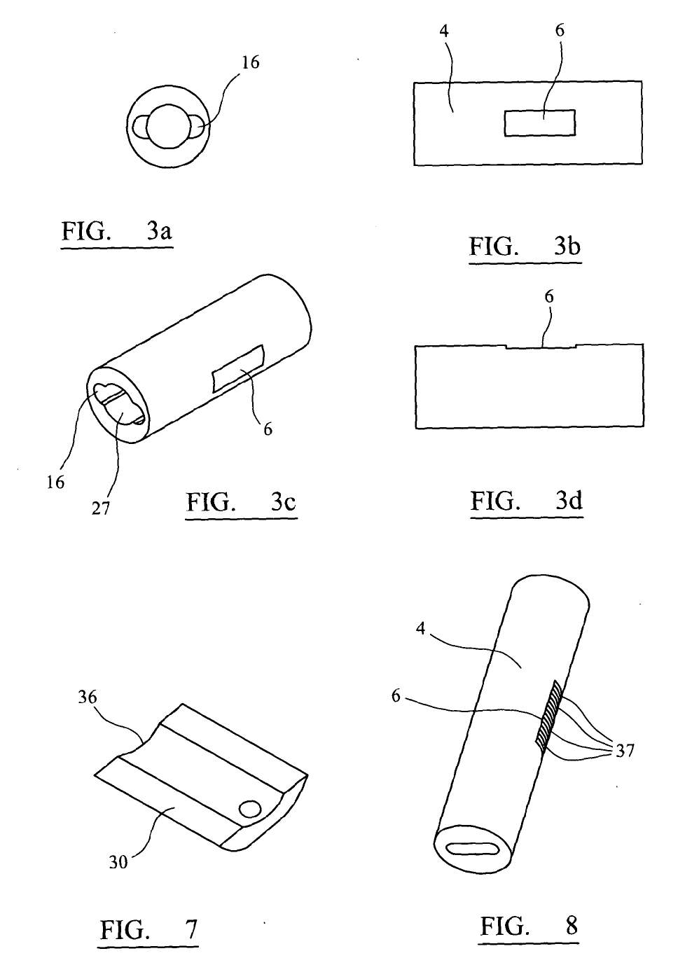

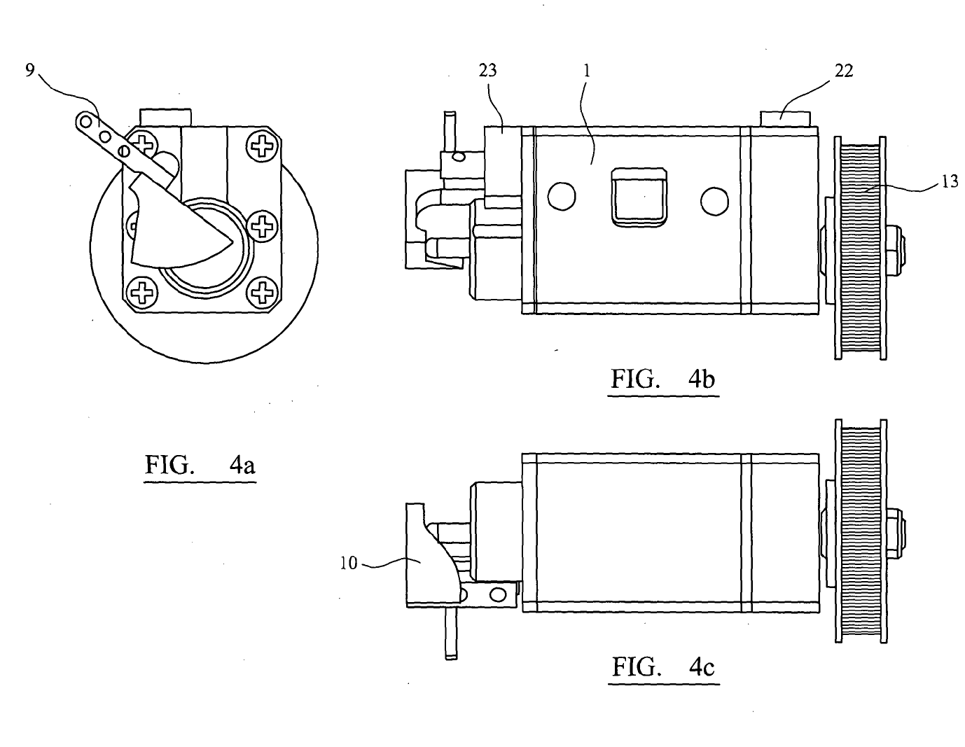

The rotating barrel carburetor 1 consists of a carburetor body 2 incorporating a fuel passage 3, a rotating barrel 4 and an air passage 5. The rotating barrel 4 has one side exposed to the fuel passage 3 and one side exposed to the air passage 5. The rotating barrel 4 is tightly toleranced within the carburetor body 2 to prevent fuel leaking up the sides of the rotating barrel 4. The rotating barrel 4 is shown in greater detail in FIGS. 3a, 3b, 3c and 3d. The rotating barrel 4 has a fuel carrying indent 6. This indent 6 comprises a small flat machined into the surface of the barrel. The rotating barrel 4 also has a slot 16 which engages with the drive coupling 15. It also contains a cylindrical spring cavity 27.

The carburetor mechanism is rotated by a pulley 13 coupled to the engine (not shown) by a toothed belt (not shown) so as to rotate at half engine speed. The pulley 19 is coupled to the drive shaft 14. This drives the rotating barrel 4 by a drive coupling 15 which is engaged with a slot 16 in the rotating barrel 4.

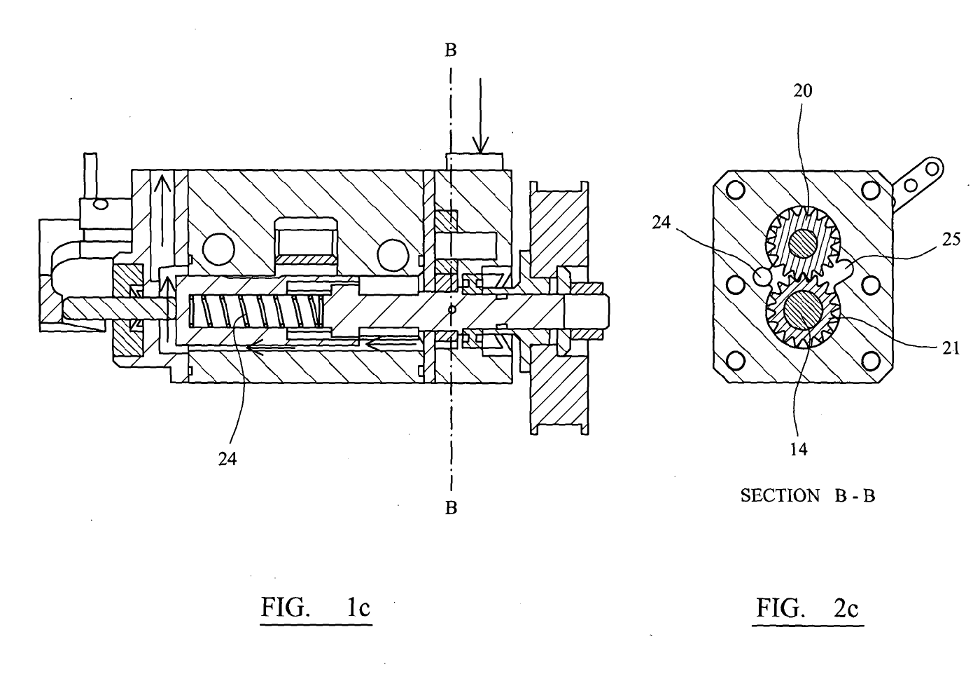

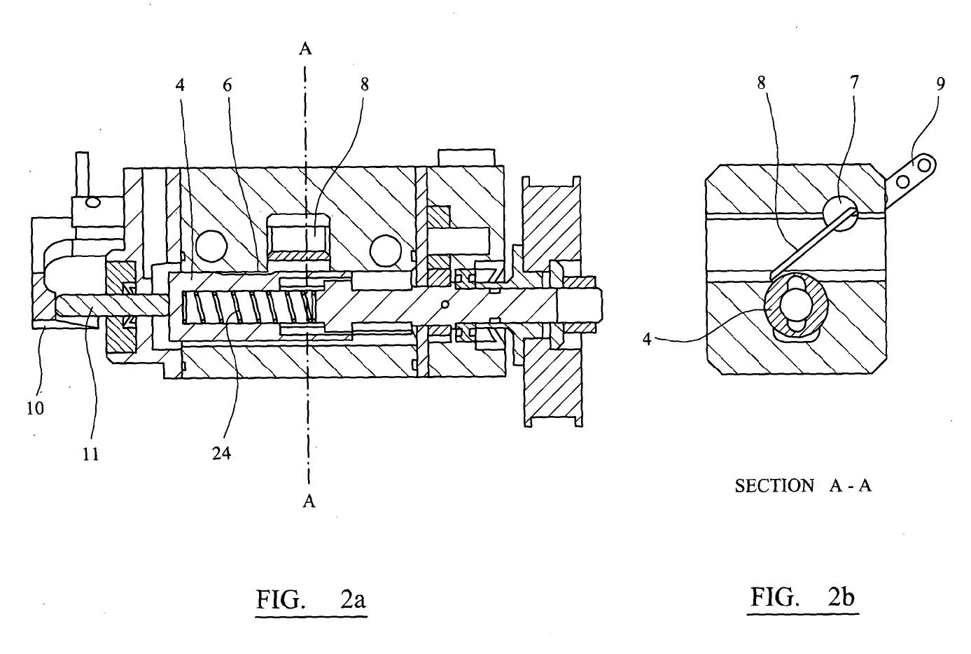

A fuel supply pump 19 is also driven by the drive shaft 14. The fuel supply pump in this embodiment is a conventional twin gear pump. This is shown in FIG. 1c. FIG. 2c shows a sectional end view of the pump 19 along the line B-B of FIG. 1c. This pump consists of a pump driven gear 21 coupled to the drive shaft 14, and a pump idler gear 20. The fuel supply pump 19 draws fuel from the tank through the fuel inlet 22 then through a fuel input passage 25 and then pushes it out through an internal passage 25 which is coupled to the fuel passage 3. The fuel is pushed through the fuel passage 3 and exits via the fuel outlet 23 and returns back to the fuel tank. It can be seen that the requirement for the pump is to supply a reasonable fuel flow at low pressures, therefore a wide variety of low cost pumps or impellers or even gravity could be employed to achieve the required flow along the fuel passage 3.

As the rotating barrel 4 rotates within the carburetor body 2 the fuel carrying indent 6 picks up fuel from the fuel passage 3 and transfers it to the air passage 5.

Normally the rotation of the rotating barrel 4 is timed such that the fuel carrying indent 6 is exposed to the inlet flow in the air passage 5 during the inlet stroke such that the air flow during the inlet stroke strips the fuel from the fuel carrying indent 6. The fuel carrying indent 6 will then carry air back to the fuel passage 3. The fuel flow in the fuel passage 3 generated by the fuel supply pump 19 will then displace this air from the fuel carrying indent 6 and replace it with a fresh packet of fuel. The air will then be carried back to the fuel tank via the fuel outlet 23.

As can be seen the primary determinant of the amount of fuel transferred will be the volume of the fuel carrying indent 6. Metering of the fuel is accomplished by varying the proportion of the fuel carrying indent 6 that is exposed to the air passage 5. On this embodiment this is accomplished by varying the position of the rotating barrel 4.

The position of the rotating barrel 4 is controlled by the fuel cam 10 and push rod 11. The fuel cam 10 is attached to the throttle axle 7. As the throttle axle 7 is rotated by the throttle lever 9 the fuel cam 10 bears on the push rod 11 which in turn bears on the rotating barrel 4. The rotating barrel 4 is forced against the pushrod 11 by a compression spring 24 which is inserted within the spring cavity 27. The other end of the spring bears against the end of the drive shaft 14. Thus as the throttle axle 7 is rotated the fuel cam 10 moves the rotating barrel 4 in and out, exposing a variable proportion of the fuel carrying indent 6 to the air passage 5 to control the amount of fuel entering the engine.

The throttle plate 8 is also attached to the throttle axle 7. The angle of the throttle plate controls the amount of air entering the engine via the air passage 5. Thus it can be seen that as the throttle axle 7 is rotated the amount of air entering the engine is governed by the angle of the throttle plate 8 and the amount of fuel entering the engine is governed by the position of the rotating barrel 4, the relationship between the two, and thus the mapping of the engine, being governed by the shape and position of the fuel cam 10.

FIGS. 1a and 1b shows the engine at full throttle. The throttle plate 8 is fully open to allow the maximum amount of air into the engine. The fuel cam 10 pushes, via the pushrod 11, the rotating barrel 4 towards the air passage 5 exposing, on this particular example, around 80% of the fuel carrying indent 6 to the air passage 5. This would be typical of a practical tune where the full fuel delivery of the fuelling device, in this case the fuel carrying indent 6 being exposed 100%, would normally be slightly greater than the maximum required by the engine.

FIGS. 2a and 2b shows the engine at low throttle. The throttle plate 8 is nearly closed to allow only a small amount of air into the engine. The fuel cam 10 has rotated around and allowed the rotating barrel 4 to move away from the air passage exposing, on this particular example, around 20% of the fuel carrying indent 6 to the air passage 5. This would be a typical fuelling amount for low throttle or idle operation.

It can be seen that the throttle plate 8 is designed so that at low throttles the air flow is forced directly over the top of the rotating barrel 4 to optimize atomization of the fuel.

It can be appreciated that the position of the rotating barrel 4 could be determined by an electronic actuator under the control of an engine management ECU. This would enable fully mapped fuelling of an engine, or effectively a fuel injection system without the need for high pressure pump and fuel plumbing.

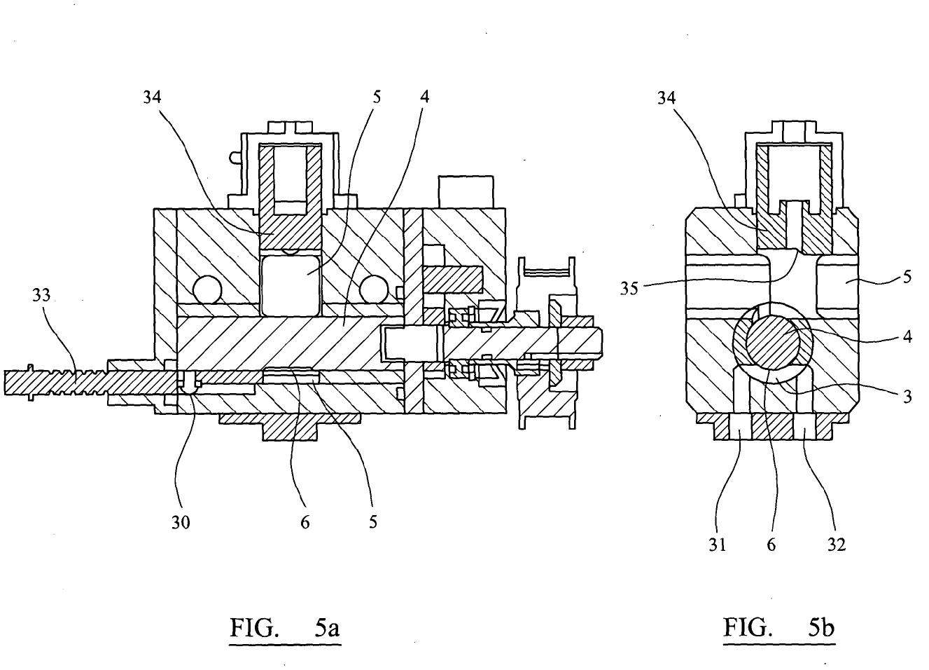

Referring now to FIGS. 5a and 5b there is shown a second example of a rotating barrel carburetor. In this embodiment the amount of fuel carried between the fuel passage and the air passage is varied by moving a metering slider 30 to mask the amount of the fuel carrying indent 6 that is exposed to the fuel in the fuel passage 3.

This embodiment is similar in operation to the previous embodiment, the main difference being that the rotating barrel 4 is now fixed in position and cannot move in an axial direction. To vary the amount of fuel delivered from the fuel passage 3 to the air passage 5a metering slider 30 is moved across the face of the rotating barrel 4 in the region where the barrel is exposed to the fuel in the fuel passage 3. The position of this metering slider 30 determines how much of the fuel carrying indent 6 picks up fuel from the fuel passage 3 and carries it round to the air passage 5.

Another difference in this embodiment which could be used in the first embodiment is that the fuel carrying indent 6 consists of a multiplicity of individual aligned slots which are covered sequentially by movement of the slider 30. This is intended to improve fuel metering by ensuring that the proportion of the fuel carrying indent 6 that is masked cannot pick up fuel from the fuel passage 3

A similar fuel supply pump 19 is driven by the drive shaft 14. In this embodiment the fuel is taken by an external pipe (not shown) from the fuel supply pump to the metering fuel inlet 31. It is then forced through the fuel passage 3 over the surface of the rotating barrel 4 and the fuel indent 6. It then exits via a fuel metering outlet 32 and returns to the fuel tank via a pipe (not shown). As in the previous embodiment the flow of fuel ensures that air bought back into the fuel passage 3 by the fuel carrying indent 6 is displaced by fresh fuel, and that the resulting air bubbles are then carried back to the fuel tank via a fuel metering outlet 32.

The position of the fuel metering slider is controlled by a control rod 33. The position of the control rod can be controlled by a cam, similar to the previous embodiment, or cable, or any suitable mechanism.

A different air control mechanism is employed on this embodiment. A throttle barrel 34 adjacent to the rotating barrel 4 controls the amount of air entering the engine. A recess 35 in the throttle barrel 34 projects over the rotating barrel 4 to ensure high air velocity over the fuel carrying indent 6 to ensure that fuel is stripped from the indent at lower throttle settings.

FIGS. 5a and 5b shows the engine at full throttle. The throttle barrel 34 is raised within the air passage to allow the maximum amount of air into the engine. The metering slider 30 is substantially withdrawn to expose most of the fuel carrying indent 6 and allow a significant amount of fuel into the engine.

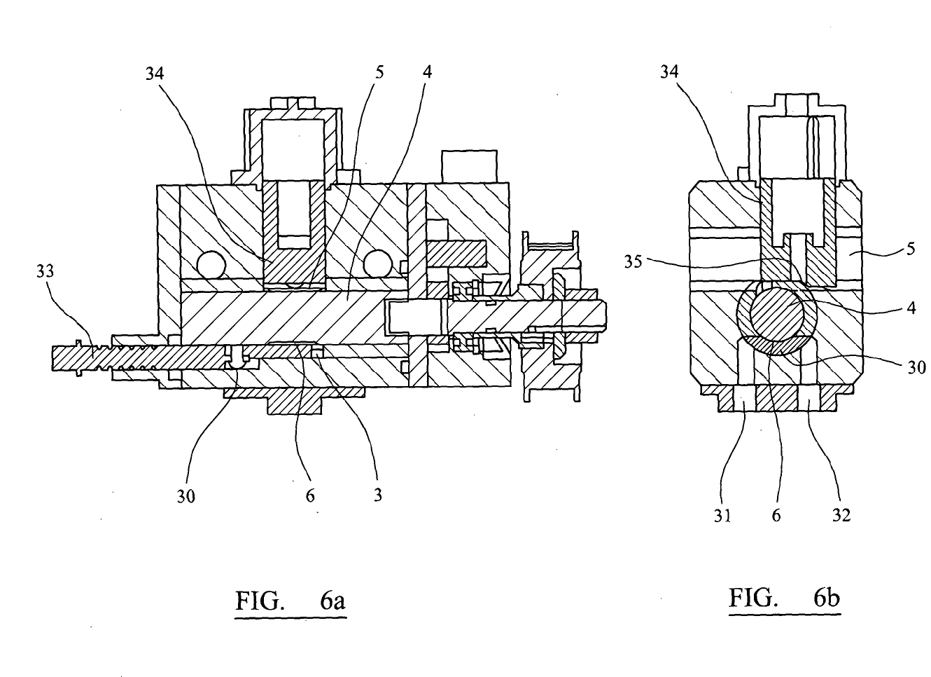

FIGS. 6a and 6b shows the engine at low throttle. The throttle barrel 34 is nearly closed to allow only a small amount of air into the engine. The metering slider 30 is substantially closed to mask most of the fuel carrying indent 6 and reduce the amount of fuel carried round to the air passage 5.

FIG. 7 shows a general external view of the metering slider 30. The internal diameter 36 of the metering slider 30 is a close match to the external diameter of the rotating barrel 4 to minimize fluid communication between the fuel passage 3 and the masked portion of the fuel carrying indent 6.

FIG. 8 shows a general external view of the rotating barrel 4 with a fuel carrying intent 6 consisting of multiple slots 37. The use of multiple slots minimizes fluid communication between the fuel passage 3 and the masked portion of the fuel carrying indent 6.

It can be appreciated that the position of the rotating barrel 4 or the metering slider 34 could be determined by an electronic actuator under the control of an engine management ECU. This would enable fully mapped fuelling of an engine, or effectively a fuel injection system without the need for high pressure pump and fuel plumbing.

An important advantage of the device shown is that it has volumetric metering of the fuel being transferred to the inlet tract. The amount of fuel is determined primarily by the dimensions of the exposed part of the fuel carrying indent. Inlet pressure, fuel viscosity, temperature and fuel supply pressure will have only secondary effects on the amount of fuel delivered. This should lead to more accurate and repeatable fuel metering.

An important advantage of the device shown is that the fuel preparation is very good. The air flow in the manifold is very high velocity and strips the fuel from the fuel carrying indent in a violent and rapid manner causing good atomization of the fuel.

An important advantage of the device shown is repeatability between devices. The actual dimensions of the fuel carrying indent, even for a small engine, are comparatively large.

The volumetric capacity of the indent is typically greater than 5 cubic milimeters. This means that it can be machined accurately and at low cost. This should lead to repeatable and more accurate fuel metering between different devices.

An important advantage of the device shown is that is resistance to blockage.

Conventional carburetors, in particular for small engines, have very small jets which are prone to blocking, in particular after a winter lay-up. The current device has no small jets, and has the mechanical rotation of the rotor to displace any contamination or gumming within the device.

An important advantage of the device shown compared to float bowl carburetors is that it has multi position operation. It is not affected by the orientation at which it is used.

An important advantage of the device shown is simplicity and robustness. Small carburetors, in particular diaphragm carburetors which are used for multi position operation, have many small parts which are vulnerable to damage, in particular plastic or rubber diaphragms and small pump mechanisms. The current device has simple and robust construction and no small vulnerable plastic or rubber parts.

Although described as a carburetor, it will be appreciated that the device could equally well be used as a variable displacement pump to transfer variable amounts of fluid between a fluid passage and a gas passage.

1. A carburetor for an internal combustion engine comprising an air passage, and a fuel passage, a rotatable barrel, the rotatable barrel being arranged between the air passage and the fuel passage so that a first portion of its surface is exposed to the air passage, and a second portion of its surface is exposed to the fuel passage, the rotation of the barrel transferring fuel from the fuel passage to the air passage via an indent feature on the surface of the barrel, fuel moving means by which the fuel within the fuel passage is caused to flow along the fuel passage and over the indent feature on the barrel, so that air brought back into the fuel passage in the indent feature is stripped from the indent feature and replaced by fresh fuel, and that the resulting air bubbles are then carried away from the region of the indent feature by the fuel flow.

2. A carburetor according to claim 1 wherein the indent feature comprises either a single indentation or multiple indentations, the amount of fuel that is conveyable from the fuel passage to the air passage being substantially determined by the volumetric size of the fuel carrying indent.

3. A carburetor according to claim 2 wherein the amount of fuel that is conveyed from the fuel passage to the air passage is varied by varying the proportion of the fuel carrying indent that is exposed to the air in the air passage and/or the fuel in the fuel passage.

4. A carburetor according to claim 3 wherein the proportion of the fuel carrying indent that is exposed to the air in the air passage and/or the fuel in the fuel passage is varied by moving the barrel in the direction parallel to its axis of rotation.

5. A carburetor according to claim 3 wherein the proportion of the fuel carrying indent that is exposed to either the air in the air passage and/or the fuel in the fuel passage is adjusted by moving a separate fuel control mask that masks a portion of the fuel carrying indent from either the air in the air passage or the fuel in the fuel passage or both, said mask being a static component that does not rotate with the barrel.

6. A carburetor according to claim 3 wherein the amount of fuel that is conveyed from the fuel passage to the air passage is varied by varying the volumetric size of the indent feature by a sliding component that occupies a variable proportion of the indent feature, the position of the component being varied to vary the volumetric size of the indent feature, said component rotating with the rotatable barrel.

7. A carburetor according to claim 1, wherein the air passage forms the inlet tract to an internal combustion engine.

8. A carburetor according to claim 1, wherein the rotatable barrel is rotated synchronously with the engine.

9. A carburetor according to claim 1, wherein the rotatable barrel is rotated by a belt driven by the engine.

10. A carburetor according to claim 1, wherein the rotatable barrel is timed so that the fuel carrying indent is exposed to the air passage during the inlet stroke of the engine so the movement of the air in the air passage will strip the fuel from the fuel carrying indent in the barrel, displacing the fuel with air which the fuel carrying indent will then carry back to the fuel passage.

11. A carburetor according to claim 1, wherein the fuel carrying indent is a single flat machined in the surface of the barrel to a known depth and length, this depth and length determining the volume of the fuel carrying indent and thus determining the amount of fuel that is transferred between the two passages for a given fuel carrying indent exposure.

12. A carburetor according to claim 1, wherein the fuel carrying indent has variable depth along its length, the variation in depth being used to map the amount of fuel that is carried between the fuel passage and the air passage for a given fuel carrying indent exposure.

13. A carburetor according to claim 1, wherein the fuel carrying indent consists of multiple indentations in the form of selectively exposable slots, the total volume of the exposed slots determining the amount of fuel that is transferred between the two passages.

14. A carburetor according to claim 1, wherein the amount of fuel that is transferred between the air passage and the fuel passage is mapped or controlled by a cam that governs the position of the rotatable barrel or fuel control mask, the shape of the cam being used to map the fuelling of the engine.

15. A carburetor according to claim 1, wherein the amount of fuel that is transferred between the air passage and the fuel passage is mapped or controlled by a separate electronic actuator that governs the position of the rotatable barrel or fuel control mask.

16. A carburetor according to claim 1, wherein a plurality of said indents are equidistantly disposed about the periphery of the rotatable barrel.
